(19) United States
(12) Patent Application Publication
(10) Pub. No.: US 2011/0205582 A1
(43) Pub. Date: Aug. 25, 2011

(54) GUIDE DISPLAY APPARATUS AND GUIDE DISPLAY METHOD

(75) Inventor: Naoki Hoshino, Saitama-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 13/029,264

(22) Filed: Feb. 17, 2011

Related U.S. Application Data
(60) Provisional application No. 61/306,022, filed on Feb. 19, 2010.

(51) Int. Cl. G06F 3/12; G06F 3/00; G06F 3/048

(52) U.S. Cl. 358/1.15; 715/705; 715/715

(57) ABSTRACT

A guide display apparatus includes a display portion, an input portion, a guide display portion, a pop-up display control portion, a setting column display portion, and a setting command portion. The guide display portion makes the display portion display a guide screen explaining an operation procedure of an apparatus. The pop-up display control portion makes the display portion display, if the user selects an object on the guide screen displayed by the guide display portion, a pop-up explaining the object while placing a button within the pop-up. The setting column display portion makes the display portion display, if the user operates the button within the pop-up, a column in which to input a setting value of the apparatus. The setting command portion sends the setting value inputted from the input portion in the input column displayed by the setting column display portion to the apparatus.

### CROSS-REFERENCE TO RELATED APPLICATION

This application is based upon and claims the benefit of priority from: U.S. provisional application 61/306,022, filed on Feb. 19, 2010; the entire contents all of which are incorporated herein by reference.

### FIELD

An embodiment described in the present specification relates to a technique to guide an operation method of an apparatus.

### BACKGROUND

A user unfamiliar with operations of an apparatus, such as an image forming apparatus, has to obtain necessary information from a manual. In some cases, a manual is provided in the form of electronic data to facilitate distribution and also to facilitate a search through contents described therein.

With a manual in the form of electric data in the related art, the user has to conduct a search using a name indicating a condition of the apparatus or a name of a portion as a keyword. If the user does not know these names, the search demands considerable time and energy. Also, even if the user obtains the necessary information from the manual, the user has to temporarily store the operation procedure when he actually starts the operation, so that he makes settings by checking an actual operation against illustrations written in the manual. This work becomes a burden to the user.

### DESCRIPTION OF THE DRAWINGS

FIG. 1 is a schematic view showing the configuration of one embodiment of the invention;

FIG. 2 is a view showing an example of functional blocks of a personal computer and an image forming apparatus of the embodiment;

FIG. 3 is a view showing an example of tables stored in a memory portion of the embodiment;

FIG. 4 is a flowchart showing an example of operations in the embodiment;

FIG. 5 is a view showing an example of a guide screen displayed by the personal computer of the embodiment;

FIG. 6 is a view showing an example of a pop-up displayed by the personal computer of the embodiment;

FIG. 7 is a view showing an example where a button is placed on the pop-up screen displayed by the personal computer of the embodiment;

FIG. 8 is a view showing an example of a confirmation screen displayed by the personal computer of the embodiment;

FIG. 9 is a view showing an example of a setting screen displayed by the personal computer of the embodiment;

FIG. 10 is a view showing an example of tables after a setting change stored in the memory portion of the embodiment;

FIG. 11 is a view showing an example of a pop-up for administrator after a setting change displayed by the personal computer of the embodiment; and

FIG. 12 is a view showing an example of a pop-up for general user after a setting change displayed by the personal computer of the embodiment.

### DETAILED DESCRIPTION

A guide display apparatus of an embodiment includes a display portion, an input portion, a guide display portion, a pop-up display control portion, a setting column display portion, and a setting command portion. The input portion accepts an input from the user. The guide display portion makes the display portion display a guide screen explaining an operation procedure of an apparatus. The pop-up display control portion makes the display portion display, if the user selects an object on the guide screen displayed by the guide display portion, a pop-up explaining the object while placing a button within the pop-up. The setting column display portion makes the display portion display, if the user operates the button within the pop-up via the input portion, a column in which to input a setting value of the apparatus. The setting command portion sends the setting value inputted from the input portion in the input column displayed by the setting column display portion to the apparatus.

This embodiment is a system that displays, on a display screen of a PC (Personal Computer), a quasi-image of the control panel same as that of an image forming apparatus and displays explanations of buttons and functions as the user moves the mouse up on terms or setting buttons he does not know how to operate. Herein, assume that the PC of this embodiment pre-stores WEB browser software and controls a display by this WEB browser. As an actual example, a JavaScript (registered trademark) language is used and the WEB browser controls a display by analyzing the language. This example, however, does not limit embodiments and other techniques (for example, a program in an execute form having an on-line help function) may be adopted as a method and a used language for display control.

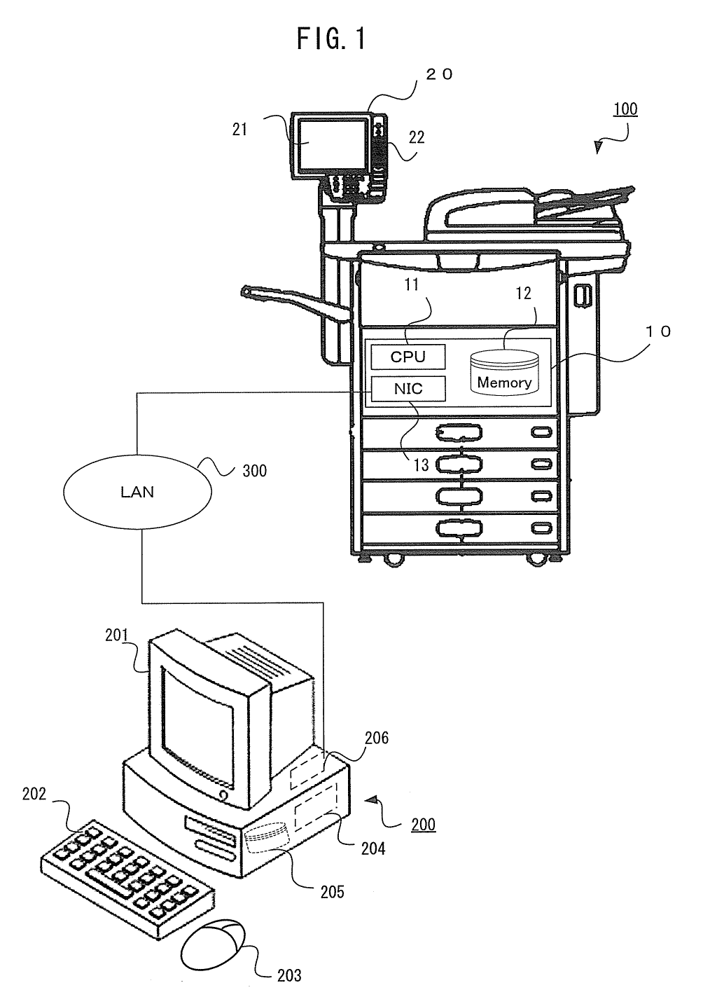

The system of this embodiment will now be described using drawings. FIG. 1 shows the configuration of the system of this embodiment. The system of this embodiment includes an image forming apparatus 100 and a PC 200 connected to each other via a LAN 300 to enable mutual communications. The image forming apparatus 100 has a control board 10 that systematically controls hardware devices in the apparatus. The control board 10 has a CPU 11 serving as an arithmetic processing unit and a memory 12 formed of a RAM (Random Access Memory) as a volatile memory device, a ROM (Read Only Memory) and an HDD (Hard Disk Drive) as a non-volatile memory device, or the like. The control board 10 also has a NIC (Network Interface Card) 13 controlling communications with an outside. The image forming apparatus 100 has a control panel 20 formed of a keyboard 22 accepting a command from the user and a touch panel display 21 displaying control content and accepting a command from the user.

A hardware configuration of the PC 200 is the same as the configuration of an existing PC and the PC 200 has a CPU 204, a memory 205, a NIC 206, a keyboard 202 accepting an input from the user, an input portion of a mouse 203, and an output portion of a monitor 201 displaying an image to the user. The NIC 13 and the NIC 206 control communications with each other via the LAN 300.

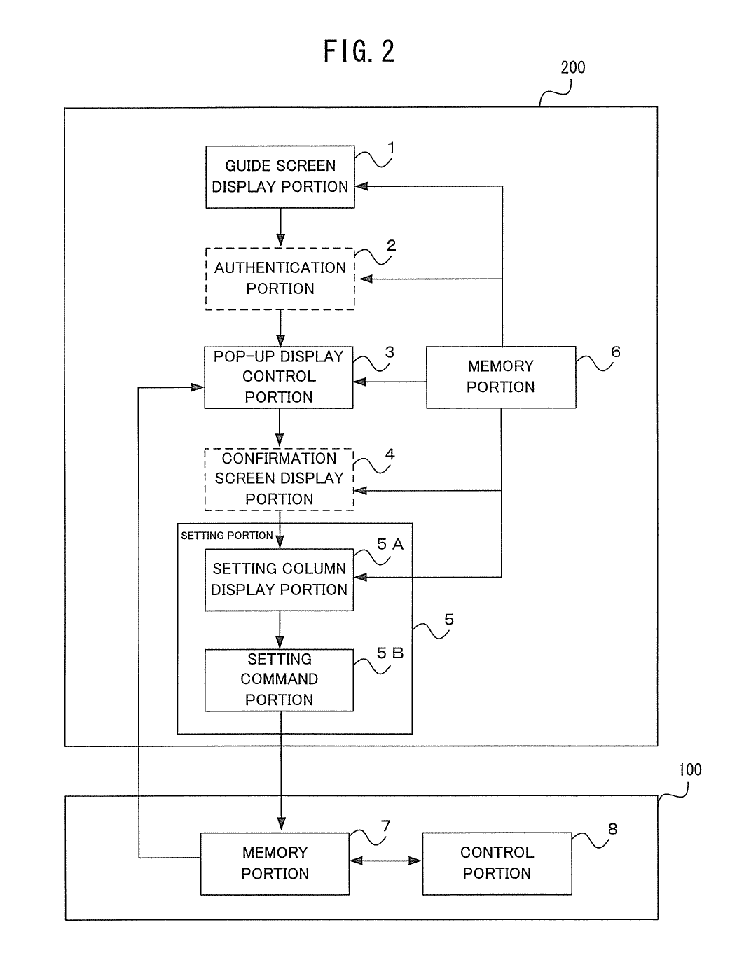

Functional blocks of each apparatus will now be described with reference to FIG. 2. The PC 200 has a guide screen display portion 1, an authentication portion 2, a pop-up display control portion 3, a confirmation screen display portion 4, a setting portion 5, and a memory portion 6.

The guide screen display portion 1 makes the monitor 201 display a guide screen explaining an operation procedure of the image forming apparatus 100. If the user selects an object on the guide screen displayed by the guide display portion 1, the pop-up display control portion 3 makes the monitor 201 display a pop-up explaining this object and also makes the monitor 201 display a button by placing the button within the pop-up.

If the user operates the button within the pop-up using the mouse 203 or the keyboard 202, the setting portion 5 makes the image forming apparatus 100 reflect the setting corresponding to the button. Also, the setting portion 5 has a setting column display portion 5A making the monitor 201 display an apparatus setting input column and a setting command portion 5B outputting a setting value obtained from the mouse 203 or the keyboard 202 using the setting column display portion 5A to the image forming apparatus 100.

The authentication portion 2 and the confirmation screen display portion 4 are auxiliary units in this embodiment. The authentication portion 2 determines whether the user is the administrator by determining whether the user inputted a predetermined password. In this embodiment, only the administrator is allowed to change the settings of the image forming apparatus 100. The invention, however, is not limited to this embodiment and a general user may be allowed to change the settings. The confirmation screen display portion 4 displays a screen for the user to confirm whether to proceed to the processing control on the setting portion 5. A configuration without the authentication portion 2 and the confirmation screen display portion 4 is also adoptable.

The memory portion 6 pre-stores various types of data used for each processing executed with PC200.

The respective units are achieved as the CPU 204 executes operations of programs pre-stored in the memory 205. Also, the pop-up display control portion 3 and the setting command portion 5B making communications with the image forming apparatus 100 are achieved by additionally including the NIC 206.

The image forming apparatus 100 has a memory portion 7 and a control portion 8. The memory portion 7 stores and changes various setting values outputted from the setting command portion 5B. The memory portion 7 stores tables (described below) correlating various types of data used by the pop-up display control portion 3. The control portion 8 controls various devices in the image forming apparatus 100 according to the respective setting values stored in the memory portion 7.

The respective units in the image forming apparatus 100 are achieved as the CPU 11 executes operations of programs pre-stored in the memory 12. The memory portion 7 makes data communications with the PC 200 by using a communication function of the NIC 13.

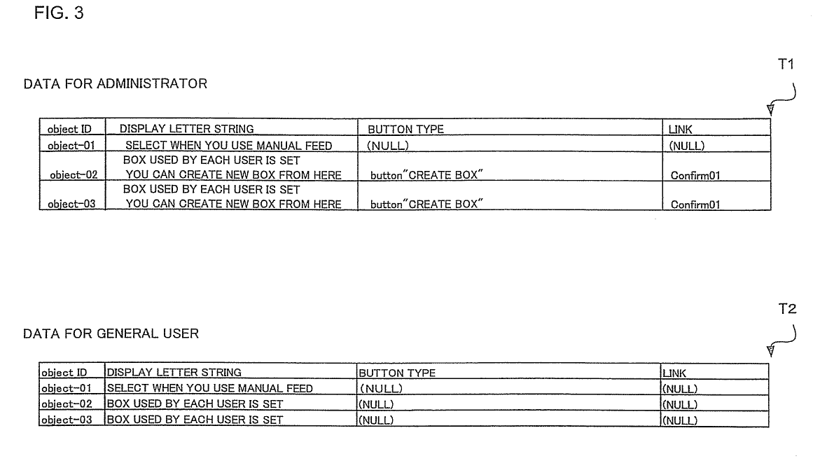

FIG. 3 shows tables stored in the memory portion 7 of the image forming apparatus 100. There are two types of tables: a table T1 for administrator and a table T2 for general user. When the administrator uses the system, the pop-up display control portion 3 refers to the table T1 for administrator and when a general user uses the system, the pop-up display control portion 3 refers to the table T2 for general user. The setting command portion 5B updates these tables.

In addition, The memory portion 7 pre-stores icons, image data, screen forms, such as html files and JavaScript files, and various types of data for display used by the respective units described above. Each table has columns for an object ID, a display letter string, a button type, and a link. The object ID is identification information on respective objects displayed by the guide screen display portion 1 (objects will be described below). The display letter string is a text displayed within a pop-up under display control of the pop-up display control portion 3. The button type shows types of buttons placed within a pop-up under the display control of the pop-up display control portion 3. In this embodiment, the button types include a normal button (“button” in an example of FIG. 3) and a selective pull-down menu (described in detail below). It should be appreciated, however, that selective buttons (for example, a radio button and a check box) are also available. In the button type column, letter strings (“create box” in the example of FIG. 3) displayed on the corresponding buttons are defined. The link is identification information on screens displayed when the corresponding buttons are pressed. In which manner the data above is used will be described below.

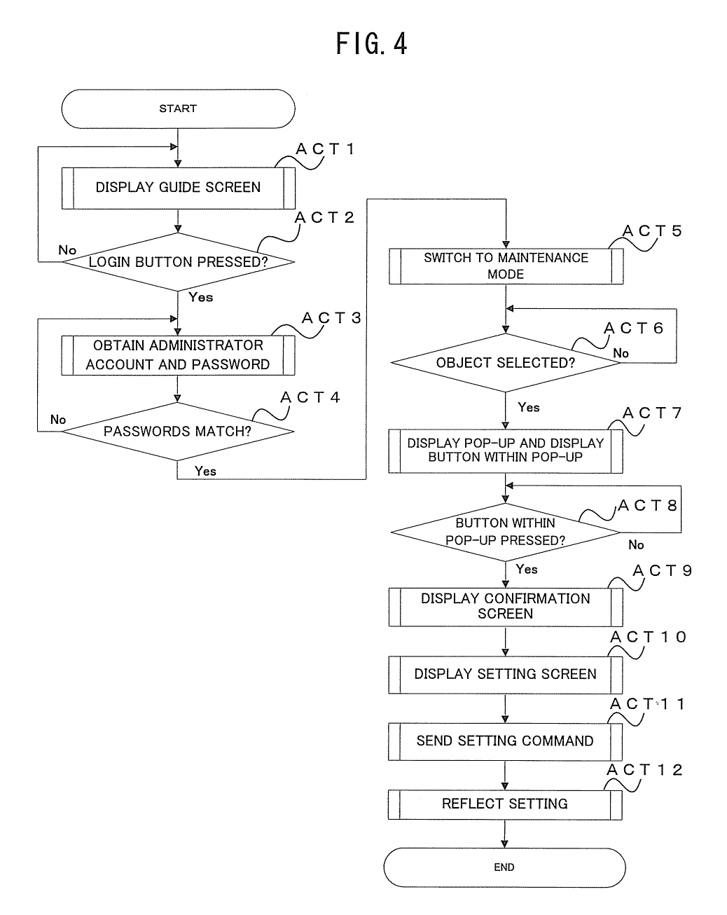

An example of operations of the system of this embodiment will now be described with reference to the flowchart of FIG. 4.

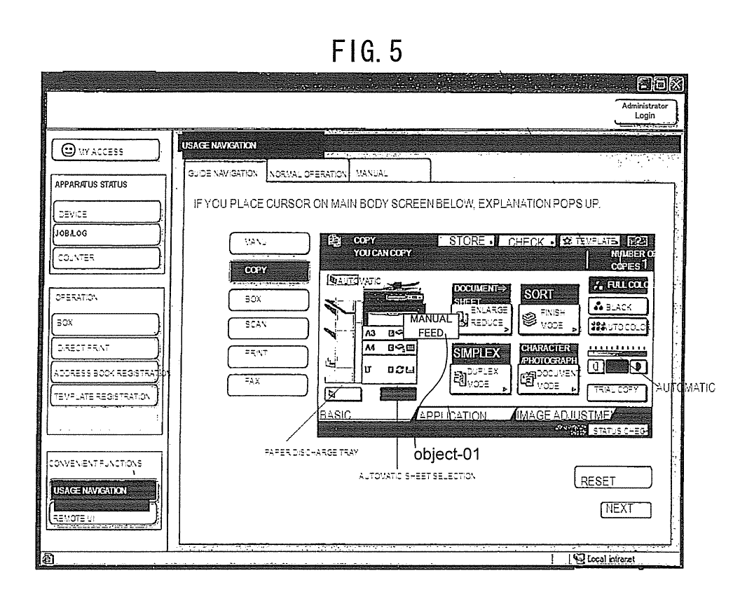

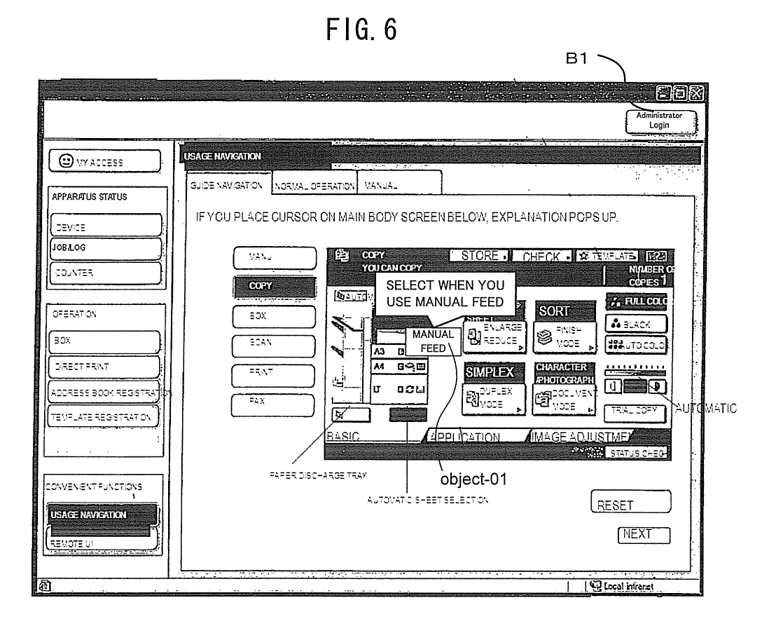

The guide screen display portion 1 makes the monitor 201 display the guide screen (ACT 1). FIG. 5 shows an example of the guide screen. In this embodiment, an icon to be displayed and accompanying data are managed collectively as one object. According to the example of FIG. 5, an object 01 is correlated with an icon exhibiting “manual feed”. If the user selects the object 01, that is, the ion exhibiting “manual feed” using the mouse 203 (the term, “select”, referred to herein means that the user moves the mouse cursor onto the icon exhibiting “manual feed”; however, the user may make a selection by pressing the object), the pop-up display control portion 3 performs control to display a pop-up. Also, the pop-up display control portion 3 searches for a record having the object 01 as the object ID from the table T2 and obtains the text in the display letter string column of this record to display the text within the pop-up. FIG. 6 shows an example in this instance. In this embodiment, a balloon pop-up (bubble pop-up) specifying the selected object is displayed.

If the user presses a login button for administrator (button B1 of FIG. 6) (ACT 2, Yes), the authentication portion 2 makes the monitor 201 display an input form of an account ID and a password for administrator. The user then inputs the account ID and the password for administrator (ACT 3) and if the password matches with a password pre-defined as the administrator's account ID (ACT 4, Yes), the PC 200 switches to a maintenance mode in which the user is allowed to change the settings of the image forming apparatus 100 (ACT 5). The user ID is also notified to the pop-up display control portion 3.

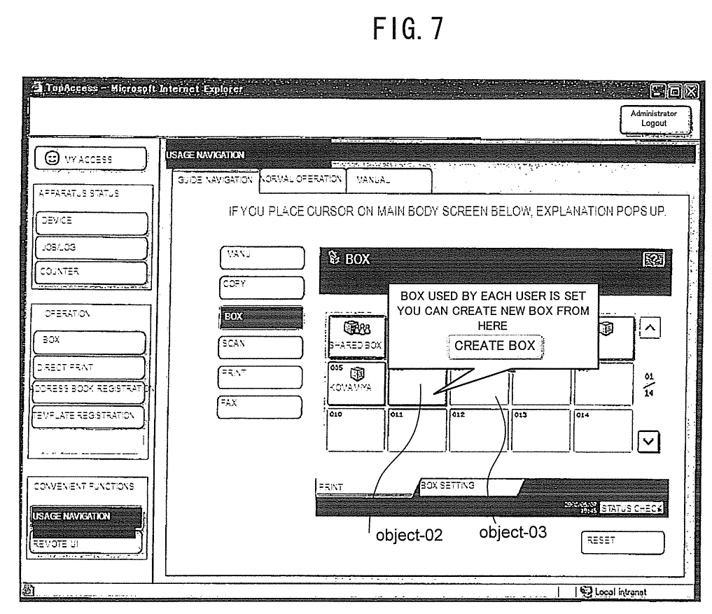

Creation of a new memory region (hereinafter, referred to as the box) in the memory 12 assigned to the user as is shown in FIG. 7 will now be described as an example of a setting change.

If the user selects an arbitrary object (ACT 6, Yes), the pop-up display control portion 3 makes the monitor 201 display a pop-up and also makes the monitor 201 display the corresponding letter string and button within the pop-up (ACT 7). Processing in this instance will be described using FIG. 7. Herein, object IDs (in the example of FIG. 7, an object 02, and an object 03, and so forth) are given to boxes of the respective users. For example, if the user moves the mouse cursor on the object 02, the monitor 201 displays a screen as is shown in FIG. 7. The pop-up display control portion 3 makes the monitor 201 display a pop-up and obtains the display letter string and the button type corresponding to the object 02 by referring to the table T1 to place the obtained letter string and button within the pop-up. The screen of FIG. 7 is displayed also to a general user. However, if the user is a general user, the pop-up display control portion 3 refers to the table T2. Because no button type (NULL) is defined for the object 02 in the Table T2, even if the user moves the mouse cursor on the object 02, only a caption, “box used by each user is set”, is displayed within the pop-up.

If the user presses the button within the pop-up (ACT 8, Yes), the confirmation screen display portion 4 refers to the table T1 and obtains a corresponding value in the link column, that is, “Confirm01” in the example of FIG. 3. The confirmation screen display portion 4 thus makes the monitor 201 display a confirmation form defined as Confirm01 (ACT 9).

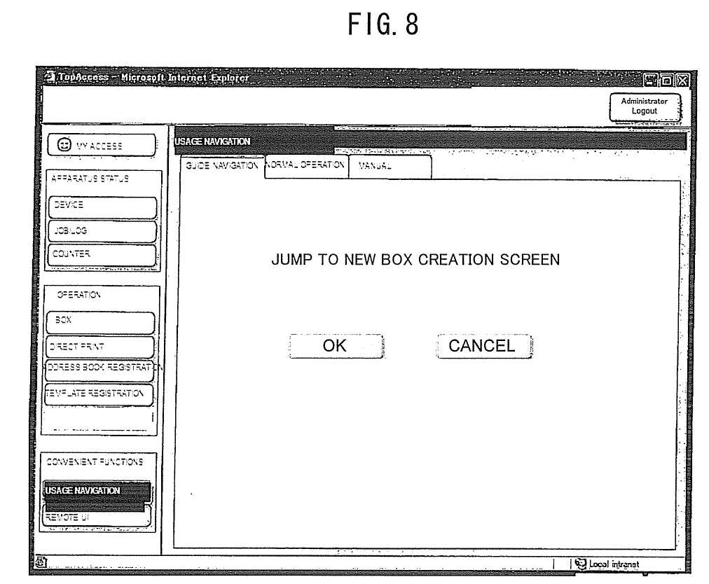

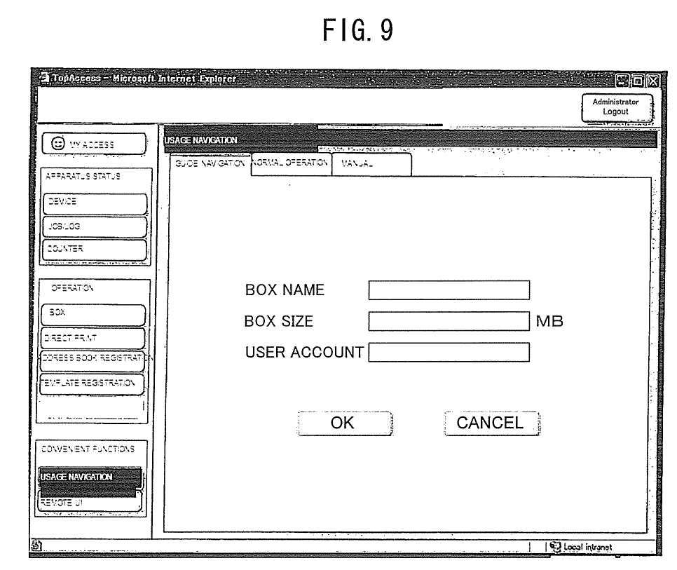

FIG. 8 shows an example of the confirmation form. If the user presses an OK button in the confirmation form shown in FIG. 8, the setting column display portion 5A makes the monitor 201 display the setting form shown in FIG. 9 (ACT 10). The user then inputs setting values (in this example, a box name, a box size, and a user account) in the setting form shown in FIG. 9. If the user presses the OK button after he inputs the setting values, the setting command portion 5B sends the respective setting vales together with a telegram of a setting change command to the image forming apparatus 100 (ACT 11). In this instance, the setting command portion 5B updates records of the respective tables in the memory portion 7, that is, records having the object 02 as the object ID in this example.

The respective setting values thus sent are stored in the memory portion 7 of the image forming apparatus 100 and the control portion 8 makes settings according to the respective setting values. In this example, the control portion 8 creates a new box in the memory 12 according the specified box name and box size and grants an access right of the specified user account to the created box.

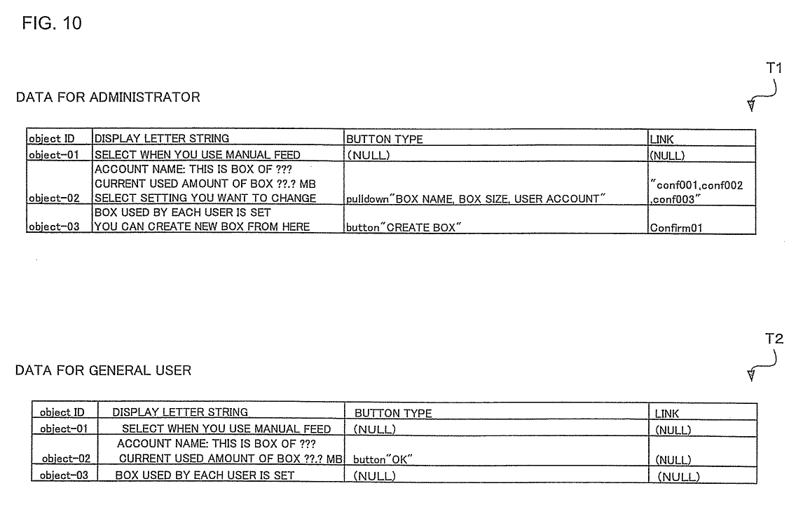

FIG. 10 shows the tables T1 and T2 after updated by the setting command portion 5B. In this example, because the user made a setting change for the object 02, the setting command portion 5B updates the respective values of the display letter string, the button type, and the link in the record of the object 02. The setting command portion 5B updates the value in the display letter string column for the object 02 to a letter string indicating the account name of the box and a used amount of the box and updates the value in the button type column to display a pull-down menu. The button type also defines respective items in the pull-down menu (in this example, “box name”, “box size”, and “user account”) and the setting command portion 5B updates the value in the link column to take forms corresponding to the respective items in the pull-down menu. In this embodiment, assume that the respective items in the pull-down menu correspond to links in order of alignment. More specifically, in the example of FIG. 10, “box name” corresponds to “conf001”, “box size” to “conf002”, and “user account” to “conf003”.

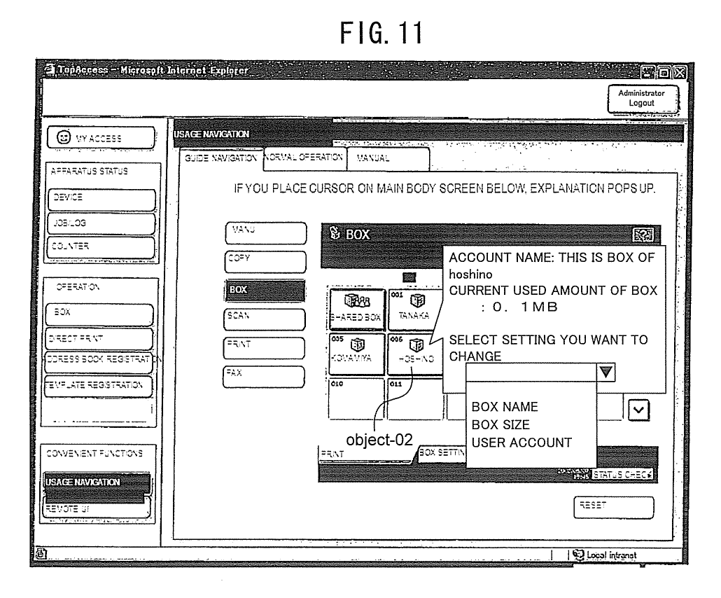

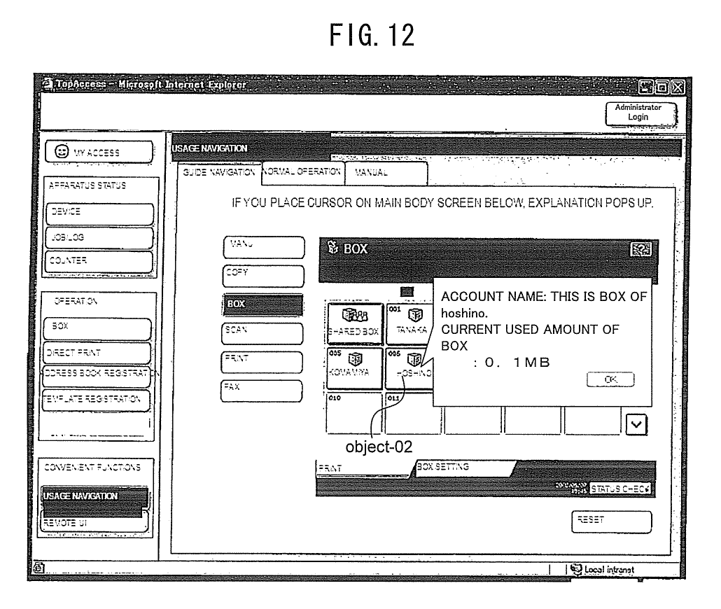

FIG. 11 shows an example of a display after the setting change as above. If the user moves the mouse cursor again on the object 02 after the setting change as above, the pop-up display control portion 3 changes the display content of the pop-up as is shown in FIG. 11 by referring to the updated record of the object 02. More specifically, the pop-up display control portion 3 displays the account name and a current used amount of the box within the pop-up (regarding the account name and an actually measured value of a used amount, assume that the pop-up display control portion 3 obtains concrete values from the memory portion 7). If the user is already verified with the administrator account ID, the pop-up display control portion 3 makes the monitor 201 display a pull-down menu having items, “box name, “box size”, and “user account” within the pop-up. If the user is a general user, the monitor 201 displays a screen as shown in FIG. 12. More specifically, because the pop-up display control portion 3 refers to the table T2, the pop-up display control portion 3 does not make the monitor 201 display the pull-down menu.

Besides the configuration described above, other execution form files in the pop-up display control portion 3 may refer to the tables T1 and T2 periodically (for example, every one minute) to overwrite data of updated columns on the corresponding portions in the respective files of the screen form.

As has been described above, the system enables the user to obtain necessary information easily in a short time without having to think a keyword or the name of a case. The user is also able to make an operation directly from the obtained information. It thus becomes possible to reduce a burden to the user when he makes the settings.

This embodiment was described on the assumption that the user makes a setting change of the image forming apparatus 100 while the PC 200 controls a display. However, the image forming apparatus 100 may include the respective functional units in the PC 200 shown in FIG. 2. In this case, the PC 200 may merely accept and display an input from the user. Alternatively, the control panel 20 of the image forming apparatus 100 may accept and display an input from the user instead of the PC 200.

If the authentication portion 2 is omitted, that is, if any user is allowed to make a setting change, only the table T1 is sufficient. If the confirmation screen display portion 4 is omitted, the values in the link column in each table are identification information of a setting change form.

The memory portion 6 of the PC 200 may hold tables T1 and T2. The memory portion 6 of the PC 200 may hold part or all of data, such as icons, stored in the memory portion 7 of the image forming apparatus 100.

This embodiment described the guiding and making a setting change of the image forming apparatus as a subject. However, apparatus other than the image forming apparatus can be also the subject. In addition, this embodiment described creation of a box as the content of a setting change. It should be appreciated, however, that this embodiment is a mere example and the invention is not limited to this embodiment.

As has been described, according to the technique described in the present specification, the convenience to the user is enhanced because the user becomes able to change a setting on the guide screen.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. A guide display apparatus, comprising:
a display portion;
an input portion that accepts an input from the user;
a guide display portion that makes the display portion display a guide screen explaining an operation procedure of an apparatus;
a pop-up display control portion that makes the display portion display, if the user selects an object on the guide screen displayed by the guide display portion, a pop-up explaining the object while placing a button within the pop-up;
a setting column display portion that makes the display portion display, if the user operates the button within the pop-up via the input portion, a column in which to input a setting value of the apparatus; and
a setting command portion that sends the setting value inputted from the input portion in the input column displayed by the setting column display portion to the apparatus.

2. The apparatus according to claim 1, wherein:
the pop-up display control portion controls a display of a caption and the button within the pop-up according to a table stored in a memory portion, in which identification information of the object displayed by the guide display portion, a text explaining the object, a type of the button, and identification information of a form of the setting column are correlated; and
the setting column display portion makes the display portion display a corresponding form of the setting column according to the table stored in the memory portion.

3. The apparatus according to claim 2, wherein:
the setting command portion updates a record of the table stored in the memory portion corresponding to the selected object.

4. The apparatus according to claim 1, further comprising:
an authentication portion that verifies the user,
wherein the setting column display portion further makes the display portion display, if the authentication portion permits, the column in which to input the setting value.

5. The apparatus according to claim 1, further comprising:
a confirmation screen display portion that makes the display portion display a screen to confirm a setting change,
wherein the setting column display portion further makes the display portion display the column in which to input the setting value upon obtainment of a confirmation command via the screen displayed by the confirmation screen display portion.

6. The apparatus according to claim 1, wherein:
the pop-up display control portion makes the display portion display a balloon pop-up specifying the selected object.

7. The apparatus according to claim 1, wherein:
the pop-up display control portion further makes the display portion display the pop-up while placing a selective pull-down menu within the pop-up.

8. The apparatus according to claim 1, wherein:
the pop-up display control portion further makes the display portion display the pop-up while placing selective buttons within the pop-up.

9. The apparatus according to claim 1, wherein:
the apparatus is an image forming apparatus.

10. The apparatus according to claim 9, wherein:
the image forming apparatus controls own devices according to the setting value sent from the setting command portion.

11. A guide display method for a computer having a display portion that displays an image to a user and an input portion that accepts an input from the user, causing the computer to:
make the display portion display a guide screen explaining an operation procedure of an apparatus;
make the display portion display, if the user selects an object on the displayed guide screen, a pop-up explaining the object while placing a button within the pop-up;
make the display portion display, if the user operates the button within the pop-up via the input portion, a column in which to input a setting value of the apparatus; and
send the setting value inputted from the input portion in the displayed input column to the apparatus.

12. The method according to claim 11, wherein:
display content within the pop-up is a table stored in a memory portion, in which identification information of the displayed object, a text explaining the object, a type of the button, and identification information of a form of the setting column are correlated; and
display of the column in which to input the setting value is to make the display portion display the corresponding form of the setting column according to the table stored in the memory portion.

13. The method according to claim 12, further causing the computer to:
update a record of the table corresponding to the selected object after the input from the input portion to the column in which to input the setting value.

14. The method according to claim 11, further causing the computer to:
verify the user, so that the computer makes the display portion display the column in which to input the setting value if the user is verified.

15. The method according to claim 11, further causing the computer to:
make the display portion display a screen to confirm a setting change, so that the computer makes the display portion display the column in which to input the setting value if a confirmation command from the user is obtained via the confirmation screen.

16. The method according to claim 11, wherein:
the pop-up is a balloon pop-up specifying the selected object.

17. The method according to claim 11, further causing the computer to:
make the display portion display the pop-up while placing a selective pull-down menu within the pop-up.

18. The method according to claim 11, further causing the computer to:
make the display portion display the pop-up while placing selective buttons within the pop-up.

19. The method according to claim 11, wherein:
the apparatus is an image forming apparatus.

20. The method according to claim 19, wherein:
the image forming apparatus controls own devices according to the setting value sent from the setting command portion.
